(19) United States
(12) Patent Application Publication
(10) Pub. No.: US 2005/0196208 A1
(43) Pub. Date: Sep. 8, 2005

(54) Business machine

(75) Inventor: Tsung-Te Lin, Taipei (TW)

Correspondence Address: QUINTERO LAW OFFICE, 1617 BROADWAY, 3RD FLOOR, SANTA MONICA, CA, 90404, US

(73) Assignee: BENQ CORPORATION, TAOYUAN (TW)

(21) Appl. No.: 11/038,290

(22) Filed: Jan. 19, 2005

(30) Foreign Application Priority Data
Feb. 3, 2004 (TW) TW93201495

(51) Int. Cl. G03G 15/00

(52) U.S. Cl. 399/362; 399/380

(57) ABSTRACT

A business machine. A cover has a guide rail, as does a main body. A first link is pivotably connected to the cover and movably disposed in the body guide rail. A second link is pivotably connected to the main body and movably disposed in the cover guide rail. When the cover moves substantially perpendicular to the main body, the first link slides in the body guide rail and the second link slides in the cover guide rail.

### BACKGROUND OF THE INVENTION

1. Field of the Invention

The present invention relates in general to a business machine and in particular to a business machine capable of scanning objects of varying thickness.

2. Description of the Related Art

A conventional business machine, such as a scanner, generally comprises a main body and a cover with an object placed therebetween for scanning. Referring to FIG. 1a, a conventional business machine has a main body 10 and a cover 20 detachably connected thereto. The cover 20 has a protrusion 21 and the main body 10 has a recess 11 receiving the protrusion 21. During scanning, an object is positioned between the cover 20 and the main body 10 with the protrusion 21 appropriately inserted into the recess 11.

The cover 20 is easily separated from the main body 10. When scanning a thicker object, the protrusion 21 is particularly prone to separation, being difficult to securely position in the recess 11. Moreover, as the depth of the recess 11 must be less than the height of the main body 10, this configuration is not suitable for a business machine requiring a thin profile.

FIG. 1b illustrates another conventional business machine provided with a main body 30 and a cover assembly 40 having a cover C, hinges 41 and 42 and a link 43. As shown in FIG. 1b, the cover assembly 40 and the main body 30 are pivotably joined by the hinges. An object T, such as a book, is placed between the main body 30 and the hinged cover assembly 40 for scanning.

With respect to FIG. 1b, however, the link 43 permanently occupies space and cannot be retracted into the main body 30. Furthermore, as the length of link 43 is fixed, it is poorly suited for scanning objects of varying thickness.

### SUMMARY OF THE INVENTION

Accordingly, an object of the present invention is to provide a business machine capable of scanning objects of varying thickness. A cover has a guide rail, as does a main body. A first link is pivotably connected to the cover and movably disposed in the body guide rail. A second link is pivotably connected to the main body and movably disposed in the cover guide rail. When the cover moves substantially perpendicular to the main body, the first link slides in the body guide rail and the second link slides in the cover guide rail.

### DESCRIPTION OF THE DRAWINGS

The present invention will become more fully understood from the detailed description given hereinbelow and the accompanying drawings, given by way of illustration only and thus not intended to be limitative of the present invention.

FIG. 1a is a perspective diagram of a conventional business machine;

FIG. 1b is a perspective diagram of another conventional business machine;

FIG. 2a is a perspective diagram of the first embodiment in accordance with the present invention;

FIG. 2b is a side view from P perspective in FIG. 2a in accordance with the present invention;

FIG. 3a is a perspective diagram of the cover elevated in accordance with the present invention;

FIG. 3b is side view from P perspective in FIG. 3a in accordance with the present invention;

FIG. 4a is a perspective diagram of the cover hinging at axis X in accordance with the present invention;

FIG. 4b is a perspective diagram of the cover assembly hinging at axes X and X′ in accordance with the present invention;

FIG. 4c is a perspective diagram of the business machine in accordance with the present invention;

FIGS. 5a and 5b are perspective diagrams of the second embodiment in accordance with the present invention; and

FIGS. 6a and 6b are perspective diagrams of the third embodiment in accordance with the present invention.

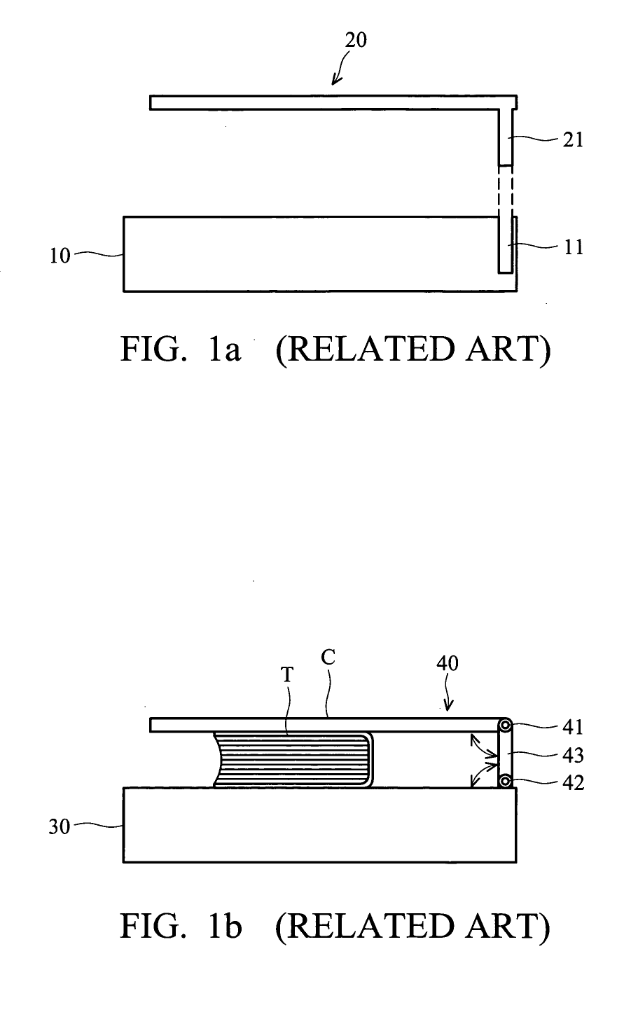

### DETAILED DESCRIPTION OF THE INVENTION

### First Embodiment

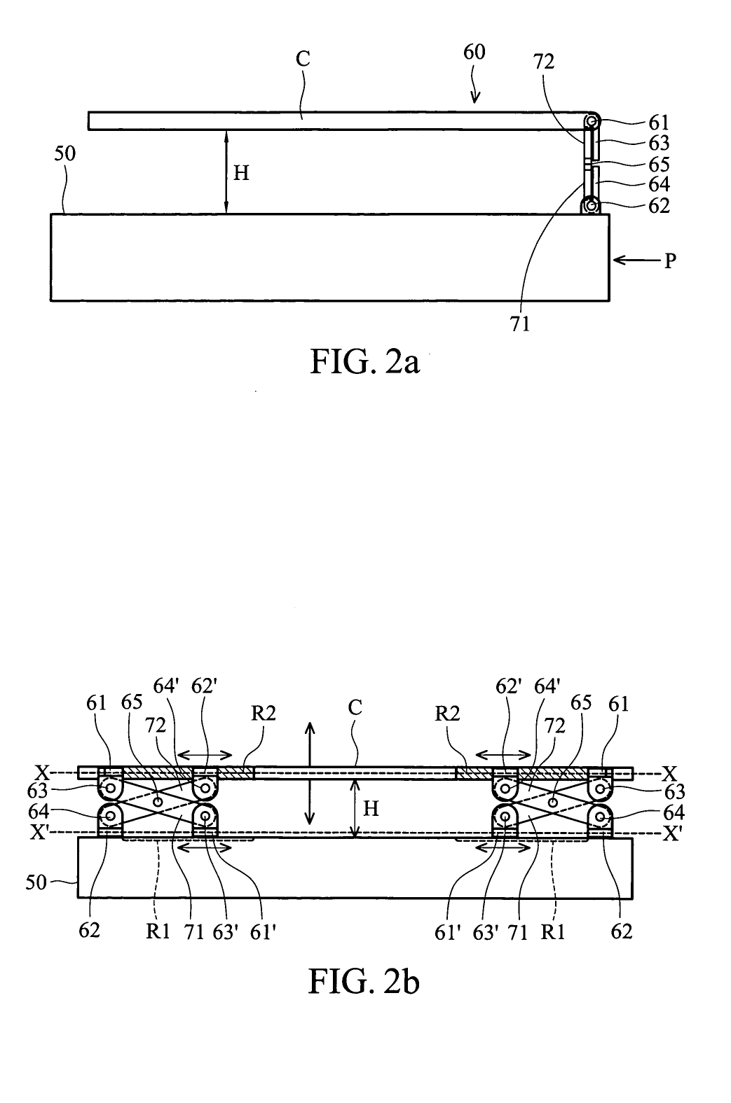

Referring to FIGS. 2a and 2b, a business machine, such as a scanner, primarily comprises a main body 50 and a cover assembly 60 provided with a cover C parallel to the main body 50, a first link 71 and a second link 72, by which the cover C and the main body 50 are pivotably connected. As shown in FIG. 2b, the cover C has a guide rail R2 at the edge thereof with a slider 62′ movably disposed therein. The slider 62′ is movable along the guide rail R2 (as indicated by the arrows) and rotatable around the axis X in accordance with the guide rail R2. Moreover, a rotating member 61 pivotably connects the cover C and the first links 71 without linear motion along the guide rail R2. Thus, the cover C hinges on the X axis with respect to the rotating member 61 and the slider 62′.

Correspondingly, in FIG. 2b, the main body 50 is provided with a guide rail R1 at the edge thereof parallel to the guide rail R2. As indicated by the arrow, a slider 61′ is movably disposed in the guide rail R1 and rotatable around the X′ axis in accordance therewith. Furthermore, a rotating member 62 pivotably connects the main body 50 and the second links 72 without linear motion along the guide rail R1. Thus, the rotating member 61 and the slider 62‘are rotatable around the X’ axis with respect to the main body 50.

In FIG. 2b, the first link 71 pivotably connects the rotating member 61 via the hinge 63 and pivotably connects the slider 61′ via the hinge 63′. Correspondingly, the second link 72 pivotably connects the rotating member 62 via the hinge 64 and pivotably connects the slider 62′ via the hinge 64′. The first link 71 and the slider 61′, or the second link 72 and the slider 61′, however, can also be integrally formed, pivotably and movably disposed in the guide rails R1, R2 respectively such as in a universal joint. In this embodiment, the first and second links 71, 72 have equal lengths and pivot via the hinge 65 located at the midpoint thereof.

As shown in FIG. 2b, two sets of the above-mentioned mechanisms are disposed on the sides of the business machine to stabilize cover C, wherein the rotating members 61 and 62 are close to the borders thereof. As indicated by the arrows, the cover C can be adjusted perpendicular to the guide rails R1, R2 with the sliders 61′, 62′ sliding therein. When scanning an object of thickness H, the cover C is movable upward or downward to appropriate height H between the main body 50 and the cover C. If the object exceeds height H, for instance, the cover C is raised accordingly.

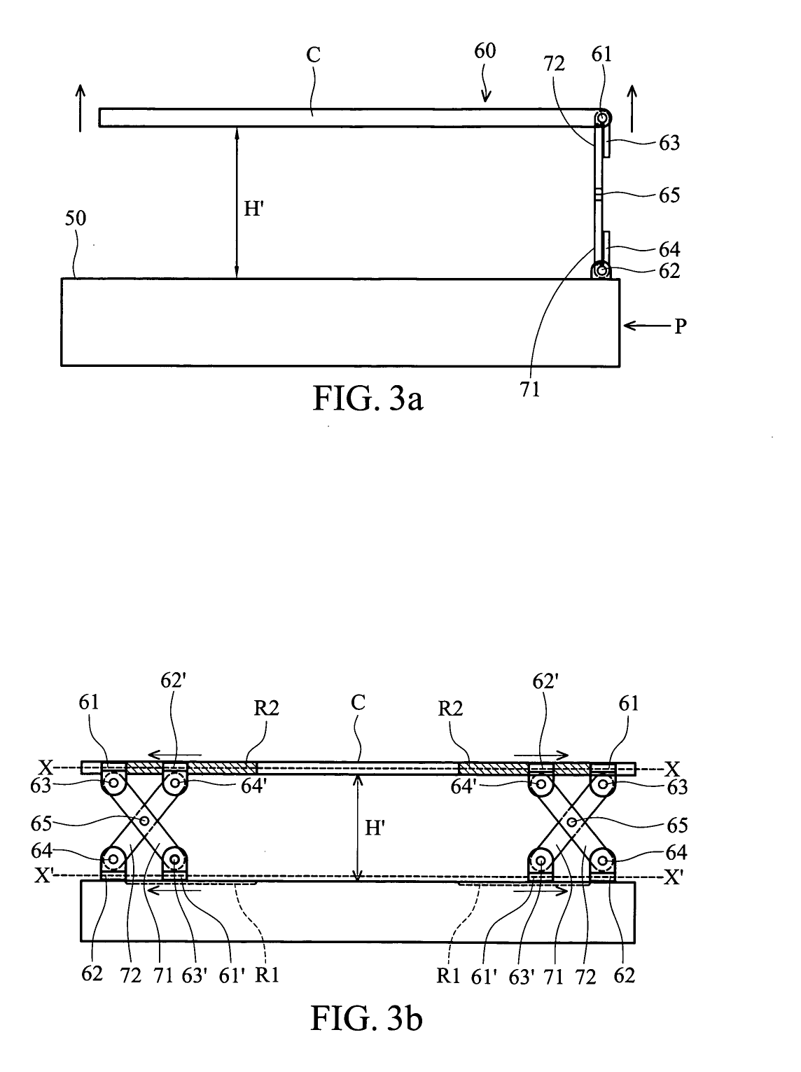

In FIGS. 3a and 3b, the cover C is raised to height H′ between the main body 50 and the cover C. When raising the cover C, the sliders 61′, 62′ move along the guide rails R1, R2 respectively as the arrows shown in FIG. 3b, the first link 71 rotates clockwise via the hinges 63, 63′, the second link 72 rotates counterclockwise via the hinges 64, 64′, the first and second links 71, 72 rotating with respect to each other via the hinge 65. As mentioned, the cover C is adjustable to appropriate height with the sliders 61′, 62′ moving along the guide rails R1, R2 respectively, enabling the business machine to be applied for objects of varying thickness.

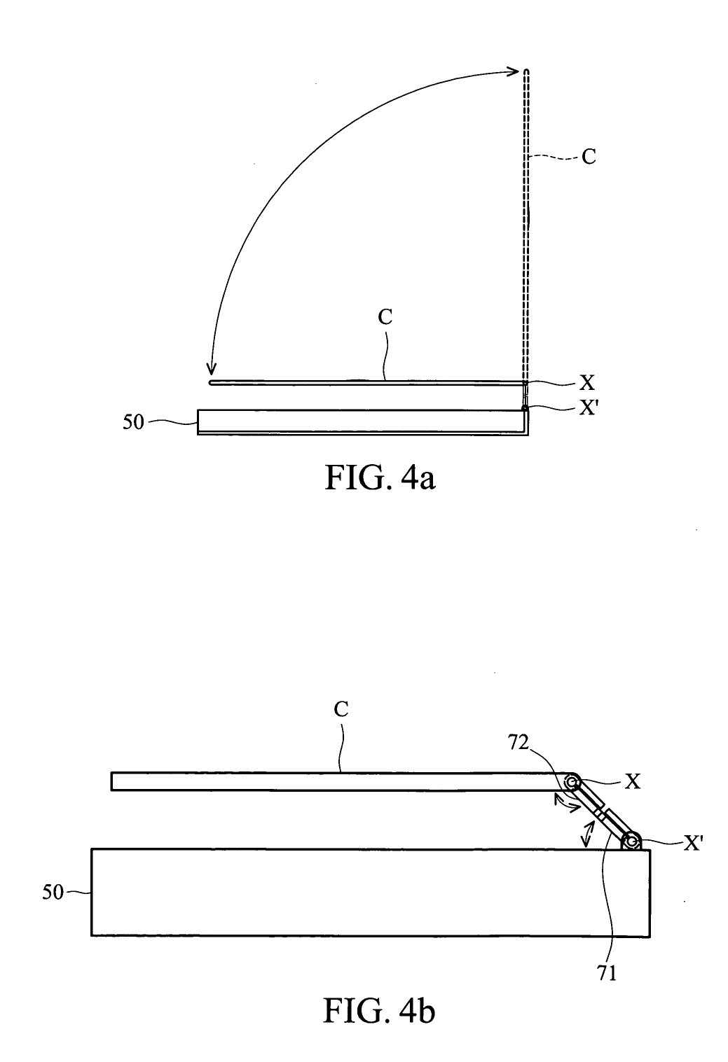

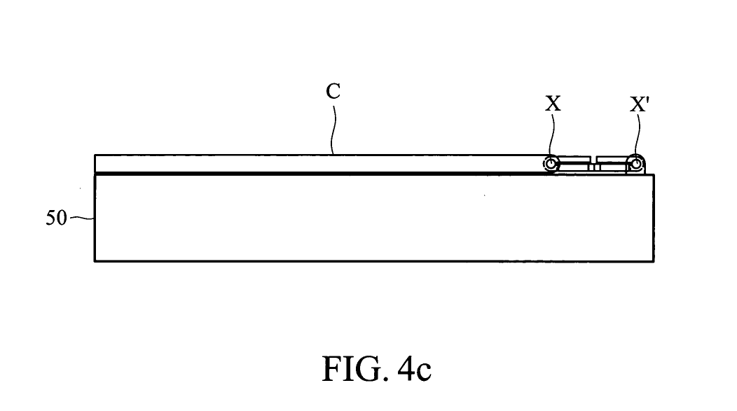

Referring to FIG. 4a, the cover C hinges around the X axis. As the arrows show in FIG. 4b, the cover assembly 60 can entirely close by cover C hinging on the X axis with the first and second links 71, 72 rotating around the axis X′. The cover assembly 60 subsequently closes with respect to the main body as shown in FIG. 4c.

### Second Embodiment

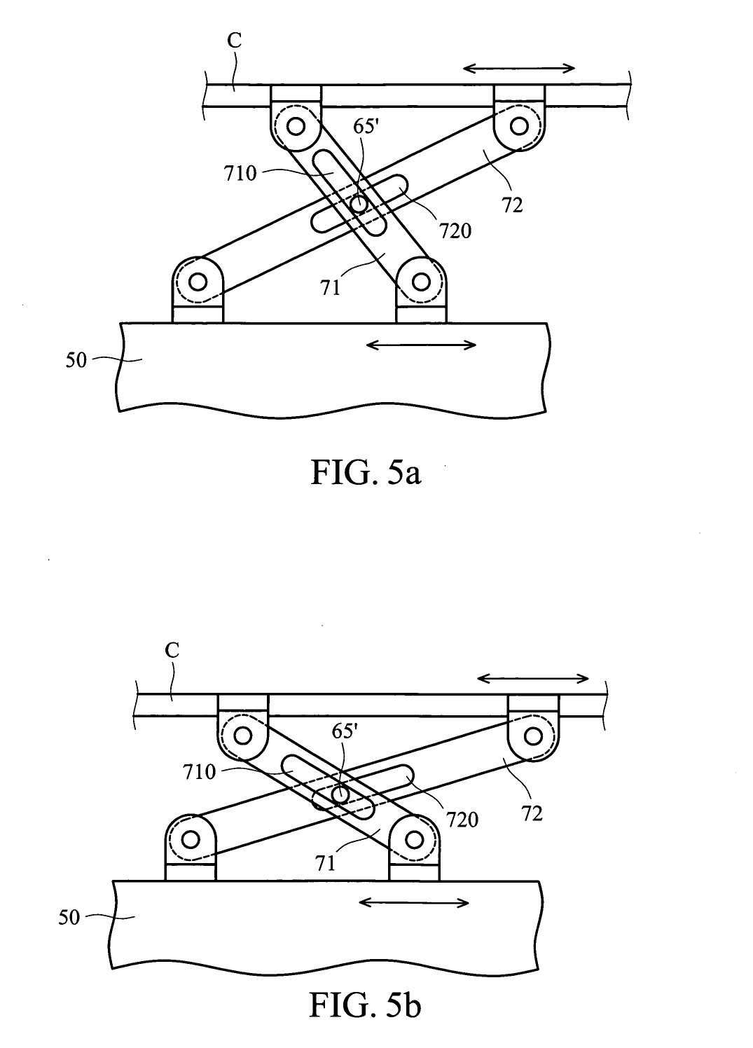

In this embodiment, the lengths of the first and second links 71, 72 are different. Referring to FIGS. 5a and 5b, the second link 72 is longer than the first link 71 with a movable hinge 65′ connected thereto. When the cover C moves with respect to the main body 50, the hinge 65′ slides in the slot 710 of the first link 71 and the slot 720 of the second link 72. Thus, the cover C is adjustable to appropriate height, allowing application for objects of varying thickness.

### Third Embodiment

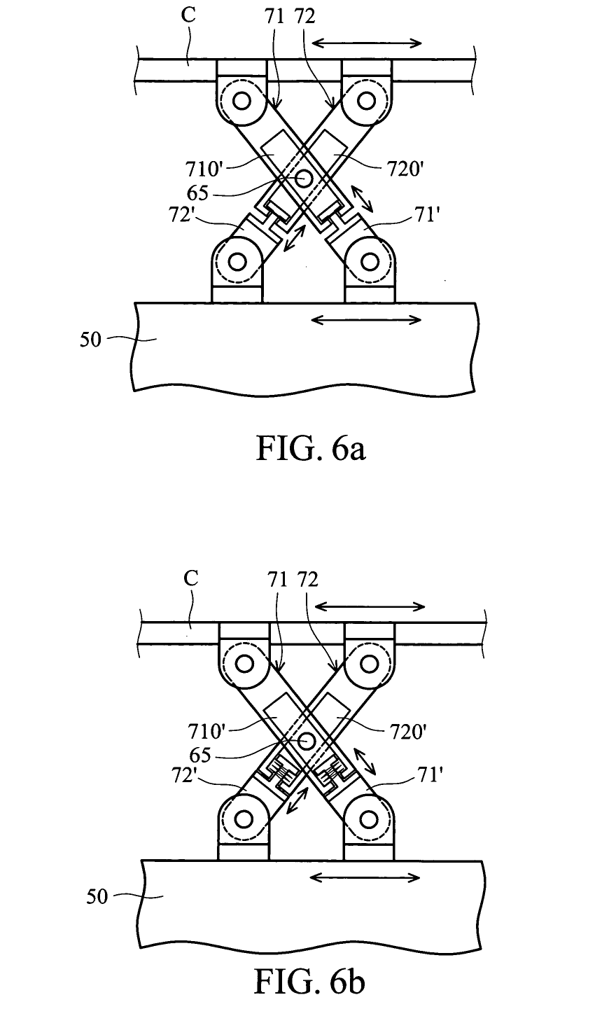

Referring to FIGS. 6a and 6b, the first and second links 71, 72 are retractable in this embodiment. As indicated by the arrows, the first link 71 has a slot 710′ with a movable portion 71′ sliding therein, and correspondingly, the second link 72 has a slot 720′ with a movable portion 72′ sliding therein. Thus, the cover C is adjustable to an appropriate height.

In summary, the present invention provides a business machine capable of scanning objects of varying thickness. By way of the adjustable links and movable sliders, the cover is easily opened or closed and profile is reduced even when longer links are applied.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation to encompass all such modifications and similar arrangements.

1. A business machine, comprising:
a cover, comprising a first guide rail;
a main body, comprising a second guide rail;
a first link pivotably connected to the cover and movably disposed in the second guide rail; and
a second link pivotably connected to the main body and movably disposed in the first guide rail, wherein the first link slides in the second guide rail and the second link slides in the first guide rail when the cover moves substantially perpendicular to the main body.

2. The business machine as claimed in claim 1 further comprising a first slider and a second slider, wherein the first slider pivotably connects the first link and is movably disposed in the second guide rail, and the second slider pivotably connects the second link and is movably disposed in the first guide rail.

3. The business machine as claimed in claim 1, wherein the first guide rail is substantially parallel to the second guide rail.

4. The business machine as claimed in claim 1, wherein the cover is substantially parallel to the main body.

5. The business machine as claimed in claim 1, wherein the first link is pivotably connected to the second link.

6. The business machine as claimed in claim 5, wherein the first link and the second link pivot at the midpoints thereof.

7. The business machine as claimed in claim 1, wherein the length of the first link is equal to that of the second link.

8. The business machine as claimed in claim 1, wherein the length of the first link is different from that of the second link.

9. The business machine as claimed in claim 1, wherein the business machine is a scanner.

10. The business machine as claimed in claim 1 further comprising a third link and a fourth link, the cover further comprising a third guide rail, the main body further having a fourth guide rail, wherein the third link pivotably connects to the cover and slides along the fourth guide rail, and the fourth link pivotably connects the main body and slides along the third guide rail when the cover moves substantially perpendicular to the main body.

11. The business machine as claimed in claim 1 further comprising a third slider and a fourth slider, wherein the third slider pivotably connects the third link and is movably disposed in the fourth guide rail, and the fourth slider pivotably connects the fourth link and is movably disposed in the third guide rail.

12. The business machine as claimed in claim 10, wherein the third guide rail is substantially parallel to the fourth guide rail.

13. The business machine as claimed in claim 10, wherein the third link pivotably connects the fourth link.

14. The business machine as claimed in claim 13, wherein the third link and the fourth link pivot at the midpoints thereof.

15. The business machine as claimed in claim 10, wherein the length of the third link is equal to that of the fourth link.

16. The business machine as claimed in claim 10, wherein the length of the third link is different from that of the fourth link.

17. The business machine as claimed in claim 1, wherein the first link is retractable.

18. The business machine as claimed in claim 17, wherein the first link comprises a first slot and a first movable portion sliding therein to vary the length of the first link.

19. The business machine as claimed in claim 17, wherein the second link is retractable.

20. The business machine as claimed in claim 19, wherein the second link comprises a second slot and a second movable portion sliding therein to vary the length of the second link.
